(19) United States
(12) Patent Application Publication
(10) Pub. No.: US 2021/0362629 A1
(43) Pub. Date: Nov. 25, 2021

(54) Handheld Seatbelt Threading Implement for Car Seats

(71) Applicant: Jeremy Millet, Mapleton, UT (US)

(72) Inventor: Jeremy Millet, Mapleton, UT (US)

(21) Appl. No.: 16/878,490

(22) Filed: May 19, 2020

(51) Int. Cl. B60N 2/28

(52) U.S. Cl. CPC B60N 2/2806; B60N 2002/2818

(57) ABSTRACT

A handheld implement for threading a seatbelt through a car seat comprising a planar semi-flexible elongated plate having a handle and tab for snagging a tongue or belt of a seatbelt and pulling or pushing said seatbelt through a recess traversing a child car seat.

### FIELD OF THE INVENTION

This invention relates to infant child vehicular safety, and more particularly relates to a handheld implement manipulatable to pull a seat belt through a child car seat for detachably connecting the tongue of seatbelt buckle to the buckle housing.

### BACKGROUND

### Description of the Related Art

Car safety seats for children have been known in the art for decades and come in a plurality of commercially available configurations adapted to secure babies, infants and children of various weights ages and sizes within automobiles.

Some of these child car seats have integrated harnesses with buckles which affix to retaining bars beneath cushions in automobiles. Most car seats, however, consist of a monolithic shell formed from polymeric materials which define a hollow interior recess traversing the car seat laterally (from side to side) through a traditional seatbelt inserts, including a lap belt or three-point belt.

Despite securing the car seat in place when a seatbelt is properly inserted through the hollow interior recess, it is very difficult for parents, guardians, caregivers, and the like to successfully insert, or thread, the seatbelt into the recess. These hollow interior recesses are designed to position behind the body of the child sitting in the car seat. As such, they are small, and often only a few centimeters or less in diameter. Parents frequently have great difficult threading the seatbelt through the car seats, particularly when a child is seated in the car seat, and there exists no tool in the art for enable parents to do so.

Further complicating their efforts, traditional seatbelts comprise a tongue which travels along the seatbelt and which is often improperly sized to easily fit through the hollow interior recess. The tongue is releasably locked in a buckle housing by a one or more cooperating locking members that engage the side edges of the tongue or a bore on the face of the tongue.

The inconvenience or the difficulty encountered by parents in trying to thread the seatbelt through car seats often leads parents to act carelessly or recklessly with regard to child safety, sometimes merely placing the seatbelt across the monolithic car seat or simply placing the car seat in an automobile without securing the car seat to the automobile at all.

There is a need in the art for a means of curing these deficiencies. It is therefore an object of the present invention to provide a handheld implement adapted for use in threading a seatbelt through a car seat preparatory to securing the car seat within an automobile.

### SUMMARY

From the foregoing discussion, it should be apparent that a need exists for a handheld implement for threading a seatbelt through a car seat. Beneficially, such a device would overcome inefficiencies with the prior art by providing an inexpensive, efficient means of quickly inserting a seatbelt through a child car seat. The present invention has been developed in response to the present state of the art, and in particular, in response to the problems and needs in the art that have not yet been fully solved by currently available apparti. Accordingly, the present invention has been developed to provide a handheld seatbelt snagging apparatus, the apparatus comprising: an elongated plate having a handle with a distal end and a proximal end, the distal end comprises a tab for snagging one of a seatbelt and a tongue of a buckle; wherein the elongated plate comprises a planar top surface and planar bottom surface.

The tab may be formed from cutting the elongated shaft. The handle may be formed from two concave recesses at the proximal end of the elongated shaft. The elongated plate may comprise two or more detachable sections.

The elongated plate may be adapted to pull a seatbelt through a hollow interior recess of a car seat. The elongated plate, in some embodiments, may be adapted to push a seatbelt through a hollow interior recess of a car seat.

A second handheld seatbelt threading apparatus is also provided, the apparatus comprising: an elongated shaft having a handle with a distal end and a proximal end, the distal end comprises a hook for snagging one of a seatbelt and a tongue of a buckle traveling on said seatbelt.

The hook may be formed from cutting the elongated shaft. The handle may be formed from two concave recesses at the proximal end of the elongated shaft.

In various embodiments, the elongated shaft comprises two or more detachable sections.

The elongated shaft may be adapted to pull a seatbelt through a hollow interior recess of a car seat. The elongated shaft may be adapted to push a seatbelt through a hollow interior recess of a car seat.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an isometric perspective view of a handheld implement for threading a seatbelt through a car seat in accordance with the present invention;

FIG. 2 is an environmental perspective view of a handheld implement for threading a seatbelt through a car seat in accordance with the present invention;

FIG. 3 is an environmental perspective view of a handheld implement for threading a seatbelt through a car seat in accordance with the present invention; and

FIG. 4 is a view of a handheld implement for threading a seatbelt through a car seat in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

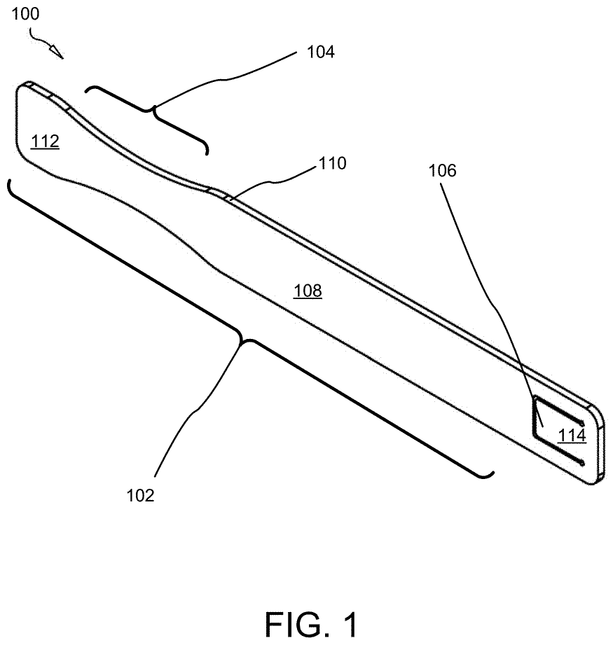

FIG. 1 is an isometric perspective view of a handheld implement 100 for threading a seatbelt through a car seat in accordance with the present invention.

The apparatus 100 may be formed from cardboard, metallic, polymeric materials, or organic materials (e.g., wood, paper or leather). Typically, the apparatus 100 is formed from a single integrated piece cut, stamped or molded from metallic or polymeric materials.

The apparatus 100 includes an elongated shaft 102 or plate having a handle 104. The apparatus 100 comprises a planar top surface 108 and a planar bottom surface. The handle 104 is formed from opposing concave indentations on the lateral edges of the apparatus 100. These side walls 110 recess inwardly to form the handle 104.

The apparatus 100 comprises a proximal end 112 and a distal end 114. The distal end 114 comprises a tab 106 formed from cutting the elongated shaft 102. The tab 106 is used to snag or hook a seatbelt or tongue on the seatbelt 206 and push or pull the seatbelt 206 through a car seat 302, further described below. The tab 106 shown is square, but the tab may be rectangular, triangular, square, or irregularly-shaped. The tab 106, in some embodiments, comprises a hook rising superiorly or inferiorly from the top surface 108.

The apparatus 100 may be rectangular or ovoid. The elongated shaft 102 may taper to a smaller width through the midsection of the elongated shaft 102 in some embodiments.

The apparatus 100 is dimensioned to be approximately the same width as a seatbelt for traveling through the same hollow interior recess of the car seat 302 as does the seat belt 206.

The tab 114 may be bent to jut outwardly from one of the planar top surface 108 and the planar bottom surface so that the tab 114 more easily snags a belt, a buckle, or a strap connected to a buckle.

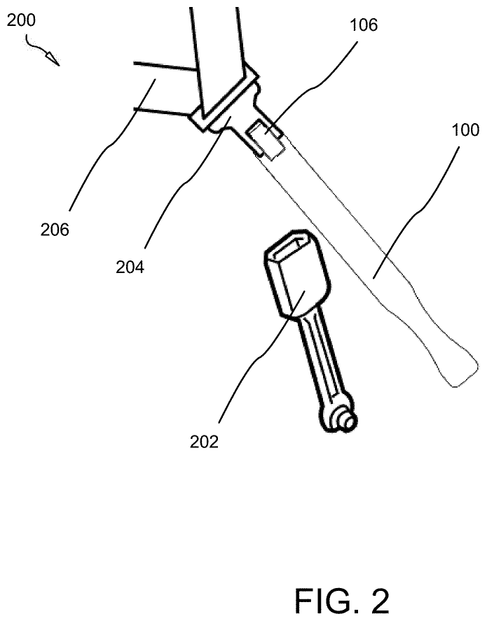

FIG. 2 is an environmental perspective view of a handheld implement 200 for threading a seatbelt through a car seat in accordance with the present invention.

As shown, the tab 106 is used to snag the tongue 204 of the seatbelt 206 and pull the seatbelt 206.

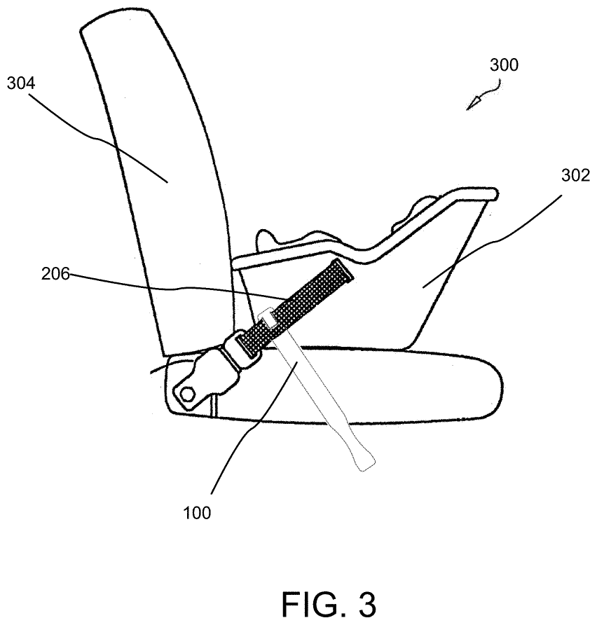

FIG. 3 is an environmental perspective view of a handheld implement 300 for threading a seatbelt through a car seat in accordance with the present invention.

In the shown embodiment, the apparatus 200 is used to snag the seatbelt 206 itself rather than the tongue. The apparatus 100 is adapted to first insert into the car seat 302 and to be pulled through the car seat 302 with the seatbelt 206 in tow.

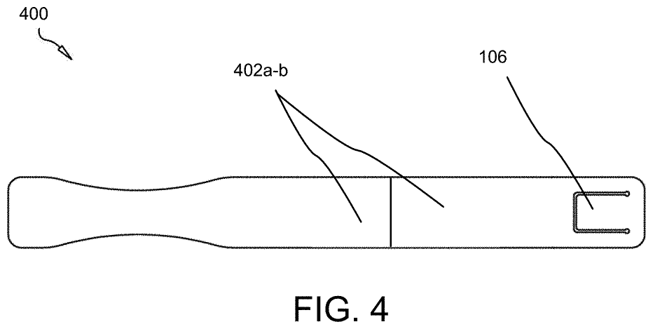

FIG. 4 is a view of a handheld implement for threading a seatbelt through a car seat in accordance with the present invention.

In various embodiments, the apparatus 400 may be folded or collapse for easier storage or integration into the car seat 302 itself. The elongated shaft 102 of the apparatus 400 may thus comprise a plurality of sections 402 which are hingedly affixed, slidably affixed, or detachable with one another.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A handheld seatbelt snagging apparatus, the apparatus comprising:
an elongated plate having a handle with a distal end and a proximal end, the distal end comprising a tab formed from cutting this distal end adapted to snag one of a seatbelt and a tongue of a buckle;
wherein the elongated plate comprises a planar top surface and planar bottom surface.

2. The handheld seatbelt snagging apparatus of claim 1, wherein the tab is formed from cutting the elongated shaft.

3. The handheld seatbelt snagging apparatus of claim 2, wherein the tab is bent outwardly between 3 mm and 10 mm from one of the planar top surface and the planar bottom surface.

4. The handheld seatbelt snagging apparatus of claim 1, wherein the handle is formed from two concave recesses at the proximal end of the elongated shaft.

5. The handheld seatbelt snagging apparatus of claim 1, wherein the elongated plate comprises two or more detachable sections.

6. The handheld seatbelt snagging apparatus of claim 1, wherein the elongated plate is adapted to pull a seatbelt through a hollow interior recess of a car seat.

7. The handheld seatbelt snagging apparatus of claim 1, wherein the elongated plate is adapted to push a seatbelt through a hollow interior recess of a car seat.

8. A handheld seatbelt threading apparatus, the apparatus comprising:
an elongated shaft having a handle with a distal end and a proximal end, the distal end comprises a hook for snagging one of a seatbelt and a tongue of a buckle traveling on said seatbelt.

9. The handheld seatbelt snagging apparatus of claim 8, wherein the hook is formed from cutting the elongated shaft.

10. The handheld seatbelt snagging apparatus of claim 8, wherein the handle is formed from two concave recesses at the proximal end of the elongated shaft.

11. The handheld seatbelt snagging apparatus of claim 8, wherein the elongated shaft comprises two or more detachable sections.

12. The handheld seatbelt snagging apparatus of claim 8, wherein the elongated shaft is adapted to pull a seatbelt through a hollow interior recess of a car seat.

13. The handheld seatbelt snagging apparatus of claim 8, wherein the elongated shaft is adapted to push a seatbelt through a hollow interior recess of a car seat.
